(19) United States
(12) Patent Application Publication
(10) Pub. No.: US 2026/0210687 A1
(43) Pub. Date: Jul. 23, 2026

(54) CALIBRATION JIG, A HORIZONTAL CALIBRATION DEVICE, AND HORIZONTAL CALIBRATION METHOD

(71) Applicant: HORNG TERNG AUTOMATION CO., LTD., Kaohsiung City (TW)

(72) Inventors: Yu-hsien WANG, Kaohsiung City (TW); Yuan-yi CHANG, Kaohsiung City (TW)

(21) Appl. No.: 19/332,098

(22) Filed: Sep. 18, 2025

(30) Foreign Application Priority Data
Jan. 21, 2025 (TW) 114102599

(51) Int. Cl. G01B 3/28; B66F 17/00; B66F 7/14

(52) U.S. Cl. CPC G01B 3/28; B66F 17/00; B66F 7/14

(57) ABSTRACT

The present invention provides a calibration jig, a horizontal calibration device, and a horizontal calibration method. The calibration jig is configured to be mounted on the horizontal calibration device and includes: a reference platform having a plurality of through holes extending through its top surface; a plurality of extension rods, each movably inserted through a corresponding through hole and extending beyond a bottom surface of the reference platform, wherein the number of extension rods corresponds to the number of through holes; and a plurality of depth gauges, each including a probe that is in contact with a top end of a corresponding extension rod, wherein the number and positions of the depth gauges correspond to those of the through holes. By using the horizontal calibration device and method of the present invention, parallel or horizontal calibration can be performed quickly and accurately.

### CROSS-REFERENCE TO RELATED APPLICATIONS

This application claims priority to Taiwan Application Serial Number 114102599, filed on January 21, 2025, which is incorporated herein by reference.

### FIELD OF INVENTION

The present invention relates to a calibration jig, a calibration device, and a calibration method, and more particularly to a calibration jig, a horizontal calibration device, and a horizontal calibration method that enable rapid and precise parallel or level calibration.

### BACKGROUND OF INVENTION

As shown in FIG. 1, a conventional load-bearing platform 1 includes a fixed plate 11 and a load-bearing plate 12, with a height adjustment mechanism 13 disposed therebetween. The height adjustment mechanism 13 includes a screw rod 131 and a nut 132. The distance between the load-bearing plate 12 and the fixed plate 11 can be adjusted by rotating the screw rod 131, and the adjusted position is secured by tightening the nut 132.

However, during the adjustment process, when it is necessary to verify the levelness of the load-bearing plate or to determine whether the load-bearing plate is parallel to the fixed plate, multiple measurements must typically be performed using a single gauge or measuring instrument. Such operations are not only time-consuming and inefficient but are also prone to human error, thereby making it difficult to achieve fast and accurate parallel calibration.

### SUMMARY OF INVENTION

One object of the present invention is to provide a calibration jig, a horizontal calibration device, and a horizontal calibration method to address the issues present in the prior art.

According to the aforementioned object, a calibration jig is provided. The calibration jig is adapted to be mounted on a horizontal calibration device. The calibration jig comprises: a reference platform having a plurality of through holes extending through a top surface thereof; a plurality of extension rods, wherein the number of the extension rods corresponds to the number of the through holes, and each extension rod is movably inserted through a corresponding one of the through holes and extends beyond a bottom surface of the reference platform; and a plurality of depth gauges, each having a probe in contact with a top end of a corresponding one of the extension rods, wherein the number and positions of the depth gauges correspond to those of the through holes.

According to an embodiment of the present invention, each extension rod comprises a head portion and a shaft portion connected to the head portion, wherein the head portion has a cross-sectional area larger than an opening of the corresponding through hole and is located on the top surface of the reference platform, and the shaft portion is inserted through the through hole.

According to an embodiment of the present invention, a bottom surface of the shaft portion is arcuate or tapered.

According to an embodiment of the present invention, a plurality of recessed structures are formed on a side surface of the reference platform and are configured to expose a plurality of height adjustment mechanisms of an object to be calibrated when the calibration jig is mounted on the horizontal calibration device.

According to the aforementioned object, a horizontal calibration device is provided. The horizontal calibration device comprises a platform frame having an open area; the aforementioned calibration jig disposed on a top of the platform frame, wherein the extension rods extend into the open area; and a lifting device disposed below the platform frame, wherein the lifting device comprises a motor, a transmission mechanism, and a supporting structure, wherein the supporting structure is configured to restrict the position of an object to be calibrated, and the transmission mechanism is connected to the supporting structure, and wherein the motor drives the supporting structure to move vertically within the open area via the transmission mechanism.

According to an embodiment of the present invention, a mounting portion is provided on a top portion of the platform frame and is configured to secure the calibration jig such that the reference platform remains horizontal.

According to the aforementioned object, a horizontal calibration method using the aforementioned horizontal calibration device is provided. The method comprises the steps of: resetting each depth gauge of the calibration jig to zero; fixing an object to be calibrated to the supporting structure; actuating the motor to drive the supporting structure upward via the transmission mechanism until a top surface of the object comes into contact with one or more of the extension rods of the calibration jig; and adjusting the level of the object until the readings of all the depth gauges become consistent.

According to an embodiment of the present invention, when the calibration jig is mounted on the platform frame, a plurality of recessed structures on a side surface of the reference platform expose a plurality of height adjustment mechanisms of the object to be calibrated, and the method further comprises adjusting the level of the object using the height adjustment mechanisms exposed by the recessed structures.

According to an embodiment of the present invention, the object to be calibrated comprises a fixed plate, a load-bearing plate disposed on one side of the fixed plate, and a plurality of height adjustment mechanisms. Each of the height adjustment mechanisms is installed between the fixed plate and the load-bearing plate and includes a screw rod, a gasket, and a fixing member. One end of the screw rod is threaded into a screw hole of the load-bearing plate, and the other end extends toward the fixed plate and has an arcuate surface. The gasket is disposed between the screw rod and the fixed plate such that a surface of the gasket facing the screw rod is in surface contact with the arcuate surface. The fixing member passes through both the screw rod and the gasket and is fixed to the fixed plate. The method further comprises rotating one or more of the screw rods to adjust the level of the load-bearing plate until the readings of all the depth gauges become consistent.

According to an embodiment of the present invention, the object to be calibrated further comprises a clamping mechanism including: a slot extending through a side surface of the load-bearing plate and communicating with the screw hole, and a fastening member being inserted into the slot from the side surface or another side surface of the load-bearing plate. The method further comprises tightening the fastening member into the load-bearing plate, thereby reducing the width of the slot and causing a deformation in the portion of the load-bearing plate around the screw hole, so as to clamp the screw.

As described above, the horizontal calibration device and method provided by the present invention primarily achieve precise horizontal calibration of an object by means of a calibration jig and a lifting device. Specifically, the platform frame and the lifting device enable accurate alignment between the calibration jig and the object, thereby ensuring measurement accuracy. In addition, the lifting device raises or lowers the object, causing the depth gauge readings to change accordingly. These readings are then used to adjust the distance between the load-bearing plate and the fixed plate, allowing the load-bearing plate to reach the desired horizontal position. Overall, the present invention provides accurate measurement and stable adjustment, making it suitable for horizontal calibration of various workpieces or products.

### DESCRIPTION OF DRAWINGS

FIG. 1 is a structural diagram of the existing load-bearing platform.

FIG. 2 is a structural diagram of a leveling adjustment device according to an embodiment of the present invention.

FIG. 3 is a schematic cross-sectional view along the A-A section line of FIG. 2.

FIG. 4 is a partially enlarged view from the dotted box in FIG. 3.

FIG. 5 is a top view of FIG. 2.

FIG. 6A is a front view of a leveling adjustment device according to an embodiment of the present invention.

FIG. 6B is a perspective schematic diagram of a leveling adjustment device according to an embodiment of the present invention.

FIG. 7A is a front view of a lifting state of a leveling adjustment device according to an embodiment of the present invention.

FIG. 7B is a perspective view of the lifting state of a leveling adjustment device according to an embodiment of the present invention.

FIG. 8 is a structural diagram of a calibration jig according to an embodiment of the present invention.

FIG. 9 is a cross-sectional view along the B-B section line of FIG. 8.

FIG. 10 is a flowchart of a horizontal calibration method according to an embodiment of the present invention.

### DETAILED DESCRIPTION OF PREFERRED EMBODIMENTS

In order to make the above and other objects, features, and advantages of the present invention more comprehensible, preferred embodiments of the present invention will be described below in detail together with the attached drawings. Furthermore, the directional terms used in the present invention, for example, up, down, top, bottom, front, back, left, right, inside, outside, side, around, central, horizontal, transverse, vertical, longitudinal, axial, radial direction, the uppermost layer, or the lowermost layer, etc. are only the directions shown in the attached drawings. Therefore, the directional terms are only used to illustrate and express the present invention, but not to limit the present invention.

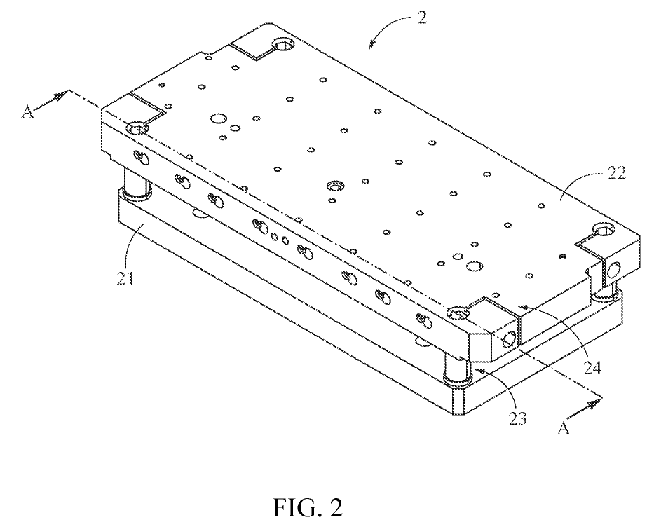

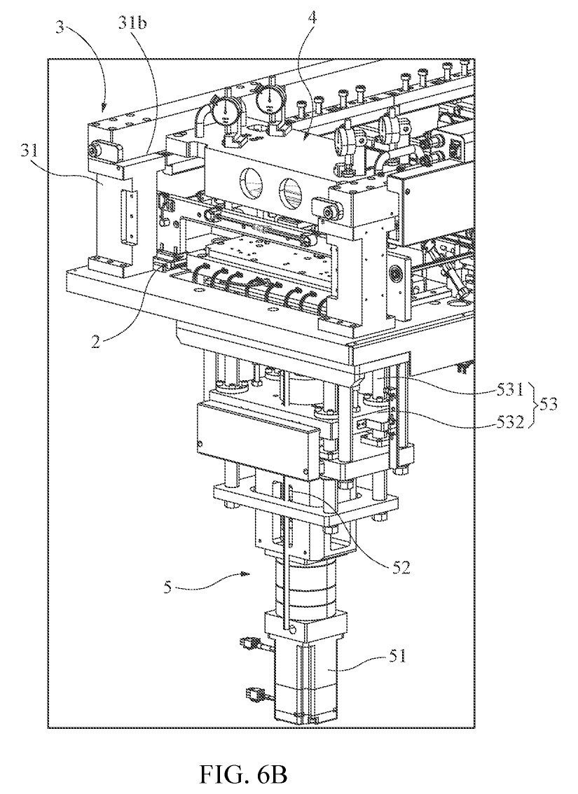

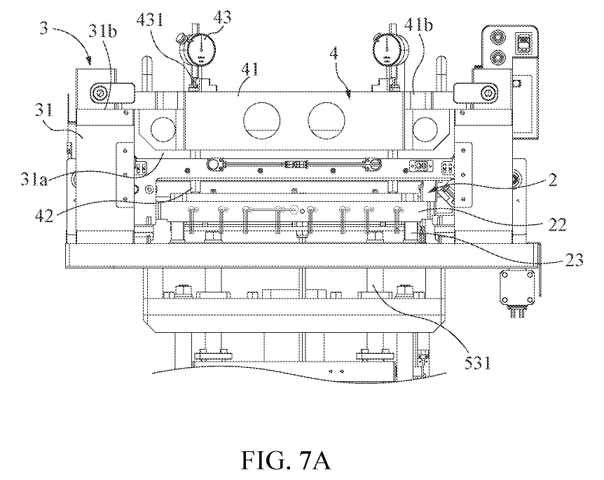

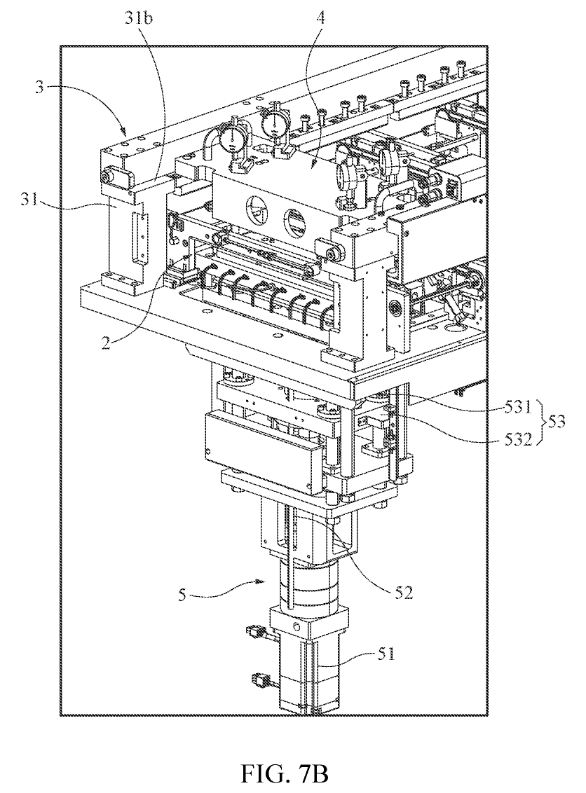

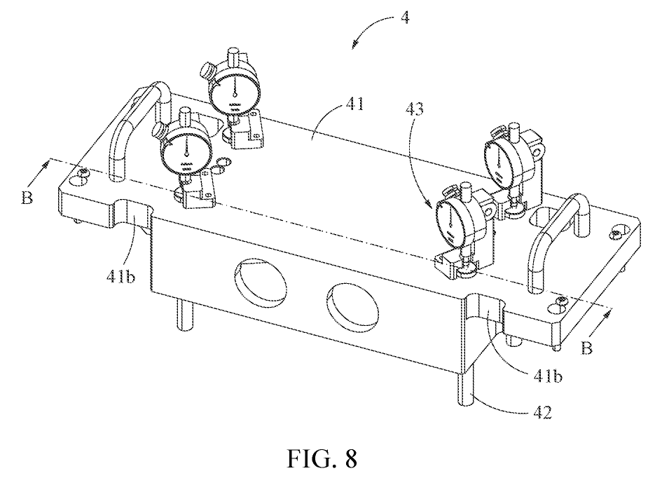

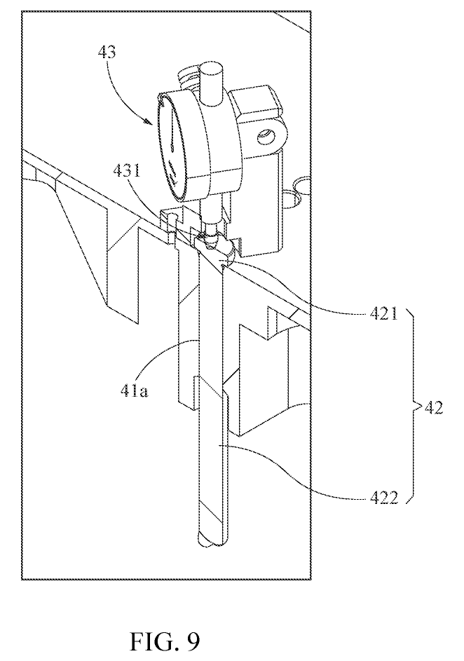

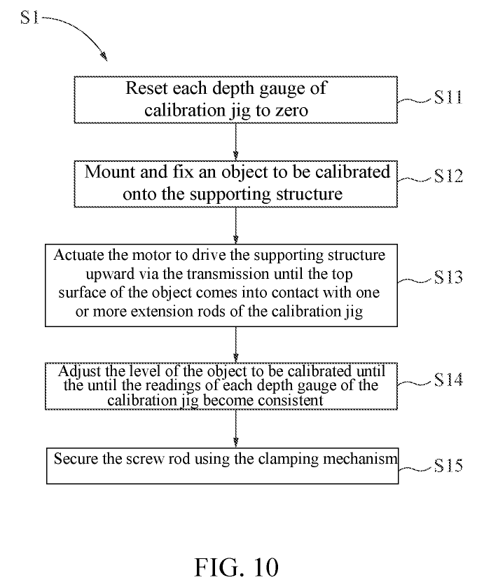

The present invention primarily provides a calibration jig (e.g., a calibration jig 4 shown in FIGS. 8 to 9), a horizontal calibration device (e.g., a horizontal calibration device 3 shown in FIGS. 6A to 7B), and a horizontal calibration method (e.g., the method illustrated in FIG. 10), which are configured to measure and assist in the horizontal adjustment of an object to be calibrated. In certain embodiments, the horizontal calibration device 3, as shown in FIGS. 6A and 6B, may be used in conjunction with a leveling adjustment device 2 illustrated in FIG. 2 to facilitate leveling operations.

Specifically, as shown in FIG. 2, the leveling adjustment device 2 includes a fixed plate 21, a load-bearing plate 22 disposed on one side of the fixed plate 21, and a plurality of height adjustment mechanisms 23. The height adjustment mechanisms 23 are installed at different positions between the fixed plate 21 and the load-bearing plate 22. In an embodiment shown in FIG. 2, four height adjustment mechanisms 23 are provided, respectively located at the four corners of the fixed plate 21 and the load-bearing plate 22. In other embodiments, the number and positions of the height adjustment mechanisms 23 may be varied according to requirements. In some embodiments, the leveling adjustment device 2 further includes clamping mechanisms 24, each corresponding to a respective height adjustment mechanism 23, and configured to lock the corresponding height adjustment mechanisms in place after the distance between the fixed plate 21 and the load-bearing plate 22 has been adjusted.

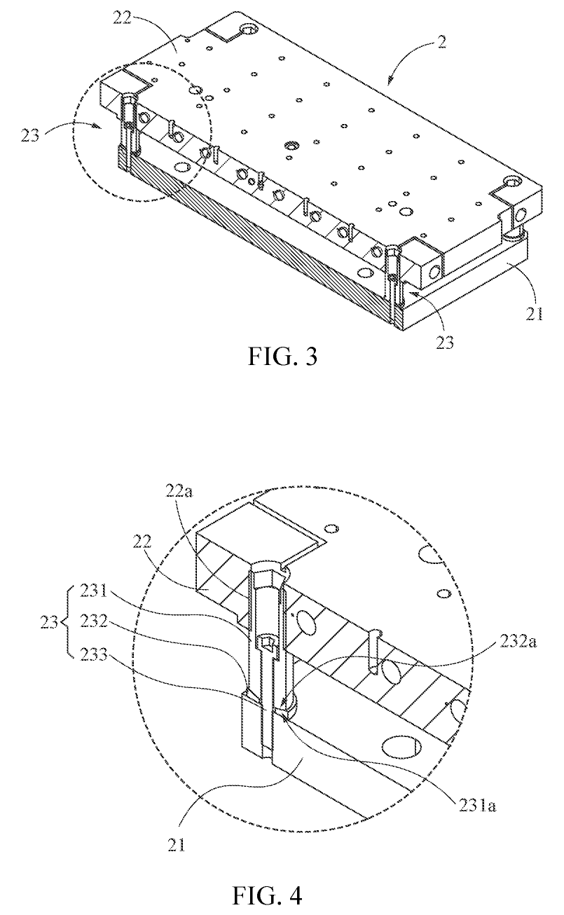

Referring to FIGS. 3 and 4, the height adjustment mechanism 23 includes a screw rod 231, a gasket 232, and a fixing member 233. One end of the screw rod 231 is threaded into a screw hole 22a of the load-bearing plate 22. The other end of the screw rod 231 extends toward the fixed plate 21 and includes an arcuate surface 231a (e.g., spherical surface). The gasket 232 is disposed between the screw rod 231 and the fixed plate 21. A surface 232a of the gasket 232 is in surface contact with the arcuate surface 231a of the screw rod 231. In one embodiment, the surface 232a of the gasket 232 may be an arcuate, spherical, or conical surface. By rotating the screw rod 231, the distance between the fixed plate 21 and the load-bearing plate 22 can be finely adjusted. Specifically, rotating the screw rod 231 into or out of the screw hole 22a of the load-bearing plate 22 changes the distance between the fixed plate 21 and the load-bearing plate 22. The design of gasket 232 ensures stable surface contact with the arcuate surface 231a of the screw rod 231, enabling uniform distribution of rotational force and reducing deflection during screw rotation. This helps maintain stable axial rotation of the screw rod 231, minimizes distance errors caused by deflection, and thereby enhances the precision of the adjustment process. The fixing member 233 passes through both the screw rod 231 and the gasket 232 and is secured to the fixed plate 21, thereby fixing the screw rod 231 in place.

In other embodiments, the gasket 232 may be omitted, allowing the arcuate surface 231a of the screw rod 231 to directly contact a surface of the fixed plate 21. This configuration enables curved-surface contact to effectively reduce errors caused by wobble or friction during the rotation of the screw rod, even in the presence of tilt or misalignment, thereby enhancing the precision and stability of the adjustment process.

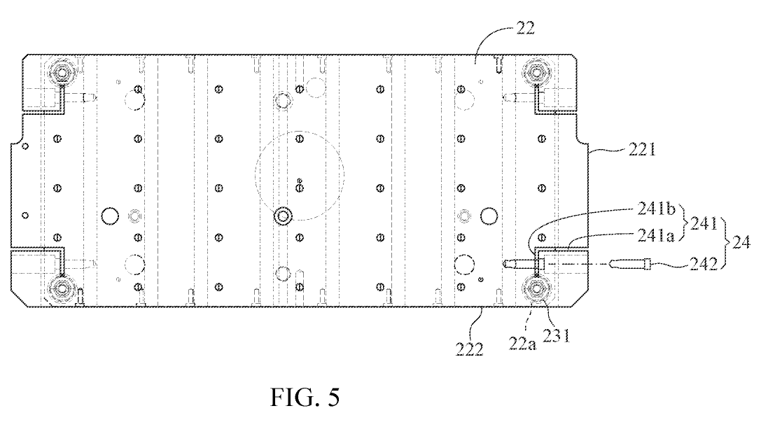

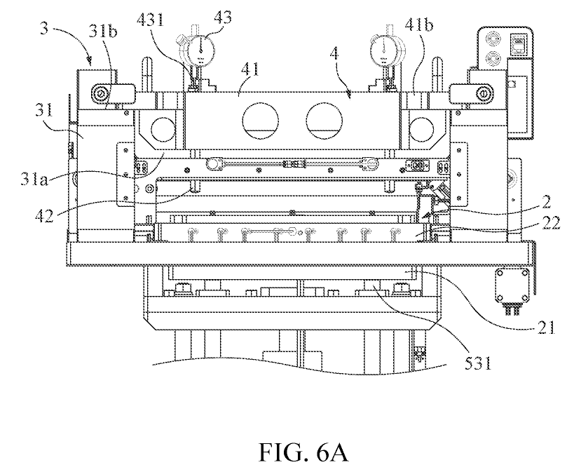

As shown in FIG. 5, the clamping mechanism 24 includes a slot 241 and a fastening member 242. The slot 241 extends through a side surface 221 of the load-bearing plate 22 and communicates with the screw hole 22a. The fastening member 242 extends through the slot 241 from the side surface 221 and is configured to reduce the width of the slot 241. Specifically, the slot 241 is designed to form a notch in the load-bearing plate 22, such that a portion of the load-bearing plate around the screw hole 22a is capable of deforming. When the fastening member 242 is tightened, it further narrows the width of the slot 241, causing the structure around the screw hole 22a to deform. This deformation enables the screw rod 231 to be securely clamped within the screw hole 22a of the load-bearing plate 22.

In the embodiment shown in FIG. 5, the slot 241 is L-shaped and includes a first slot section 241a and a second slot section 241b. The first slot section 241a extends inward from a side surface 221 of the load-bearing plate 22 in a first direction perpendicular to the side surface 221. The second slot section 241b extends from an inner end of the first slot section 241a in a second direction parallel to the side surface 221 and communicates with the screw hole 22a. The fastening member 242 passes through the load-bearing plate 22 from its side surface 221 and is tightened into the second slot section 241b, thereby narrowing the width of the second slot section 241b and correspondingly reducing the width of the first slot section 241a. Alternatively, the fastening member 242 may instead pass through another side surface of the load-bearing plate 22 (e.g., side surface 222) and be tightened into the first slot section 241a. In this configuration, tightening the fastening member reduces the width of the first slot section 241a, thereby correspondingly narrowing the second slot section 241b.

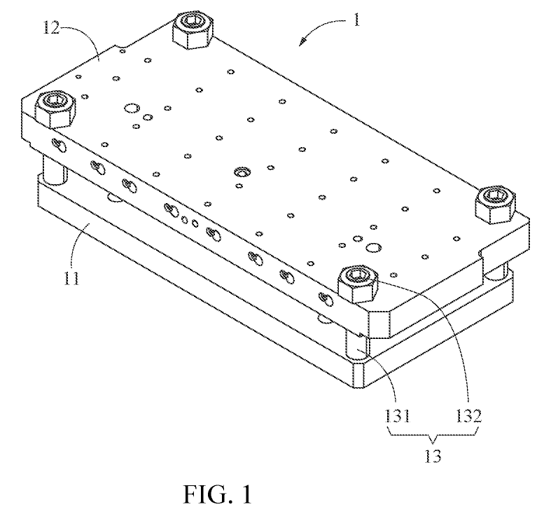

It should be noted that the clamping mechanism 24 is used in conjunction with the height adjustment mechanism 23 (as shown in FIGS. 2 to 4) to achieve optimal precision in both adjustment and fixation. However, in other embodiments, the clamping mechanism 24 may also be used in combination with the height adjustment mechanism 13 illustrated in FIG. 1, thereby addressing a drawback in the prior art wherein the nut 132, used to secure the screw rod 131, may cause unintentional rotation of the screw rod 131, adversely affecting accuracy. In the conventional technique shown in FIG. 1, the nut 132 axially locks the screw rod 131, which interferes with the axial rotation required for final distance and precision adjustments. In contrast, the clamping mechanism 24 disclosed herein radially secures the screw rod 231. Since radial fixation operates independently of the axial adjustment of the screw rod 231, this configuration enables fine-tuning of the final distance without compromising precision.

Referring to FIGS. 2 to 4, the adjustment method of the leveling adjustment device 2 is as follows. First, the height adjustment mechanisms 23 are installed between the load-bearing plate 22 and the fixed plate 21. Next, the screw rod 231 of each height adjustment mechanism 23 is rotated to adjust the depth to which it is threaded into the load-bearing plate 22, thereby changing the relative height between the load-bearing plate 22 and the fixed plate 21. During the adjustment, the gasket 232 maintains stable surface contact between the arcuate surface 231a of the screw rod 231 and the surface 232a of the gasket 232, thereby minimizing wobble and ensuring smooth and stable axial rotation of the screw rod. Since the threaded depths of the screw rods 231 at the four corners may differ, the levelness of the load-bearing plate 22 can be inspected visually or by using a leveling instrument. Fine adjustments may be performed until the load-bearing plate 22 is substantially parallel to the fixed plate 21. Once the load-bearing plate 22 reaches a desired height, the clamping mechanism 24 is used to secure the screw rod 231 in place, thereby preventing loosening and ensuring stable positioning.

In some embodiments, a horizontal calibration device 3, as illustrated in FIGS. 6A and 6B, is provided to assist in the operation of the leveling adjustment device 2, thereby enabling more precise horizontal calibration. The horizontal calibration device 3 includes a platform frame 31, a calibration jig 4, and a lifting device 5. The calibration jig 4 is disposed at the top of the platform frame 31 and is configured to measure the horizontality (or levelness) of a reference surface of an object to be calibrated (e.g., the leveling adjustment device 2). The lifting device 5 is disposed beneath the platform frame 31 and is configured to support and vertically move the leveling adjustment device 2 relative to the calibration jig 4. For example, the leveling adjustment device 2 may be lifted from an initial position shown in FIGS. 6A and 6B to a raised position shown in FIGS. 7A and 7B, thereby facilitating alignment or calibration operations under optimal and controlled conditions.

Specifically, referring to FIGS. 8 and 9, the calibration jig 4 includes a reference platform 41, a plurality of extension rods 42, and a plurality of depth gauges 43. The reference platform 41 has a plurality of through holes 41a extending through its top surface. Each extension rod 42 is movably inserted through a corresponding through hole 41a and extends downward past the bottom surface of the reference platform 41. The number of extension rods 42 corresponds to the number of through holes 41a. Each depth gauge 43 is arranged above each through hole 41a, with a probe 431 in contact with the top end of the corresponding extension rod 42. In one embodiment, each extension rod 42 includes a head portion 421 and a shaft portion 422 connected to the head portion 421. The head portion 421 is located on the top surface of the reference platform 41 and has a cross-sectional area larger than the opening of the through hole 41a, thereby preventing the extension rod 42 from slipping out of the through hole 41a. The shaft portion 422 has an outer diameter smaller than the dimension of the through hole 41a, allowing it to move freely in the vertical direction within the hole. Furthermore, since the probe 431 of each depth gauge 43 is in contact with the top of the corresponding extension rod 42, any vertical displacement of the extension rod 42 causes the probe 431 to move accordingly, resulting in a corresponding change in the depth gauge reading. This configuration enables accurate detection of height variations and facilitates precise leveling calibration.

Simultaneously referring to FIGS. 6A to 7B, the platform frame 31 includes an open area 31a and a mounting portion 31b formed on a top portion of the platform frame 31, and the mounting portion 31b has a horizontal surface. The calibration jig 4 is placed on top of the platform frame 31 and secured to the mounting portion 31b to ensure that the reference platform 41 remains horizontal during use. The extension rods 42 of the calibration jig 4 extend downward into the open area 31a and are positioned directly above the object to be calibrated (e.g., the leveling adjustment device 2), which is supported by the lifting device 5. As shown in FIG. 8, in one embodiment, multiple recessed structures 41b are formed on the sides of the reference platform 41. When the calibration jig 4 is mounted onto the horizontal calibration device 3, these recessed structures 41b are aligned with the height adjustment mechanisms 23 of the object to be calibrated. This design allows the height adjustment mechanisms 23 to be exposed while the calibration jig 4 is in place, providing sufficient space for adjusting the distance between the load-bearing plate 22 and the fixed plate 21. Specifically, in one embodiment, the four height adjustment mechanisms 23 are positioned at the four corners of the load-bearing plate 22 to allow precise multi-point leveling. Accordingly, the recessed structures 41b are positioned near the four corners of the reference platform 41 to correspond with these adjustment points.

The lifting device 5 includes a motor 51, a transmission mechanism 52, and a supporting structure 53. The supporting structure 53 is configured to restrict the position of the object to be calibrated and is operatively connected to the transmission mechanism 52. The motor 51 drives the transmission mechanism 52, which controls the vertical movement of the supporting structure 53 within the open area 31a. In this embodiment, the transmission mechanism 52 comprises a threaded rod driven by the motor 51. The supporting structure 53 includes a plurality of guide rods 531 and a lifting platform 532. The lifting platform 532 is connected to the threaded rod, and the guide rods 531 are positioned on the platform to provide stable vertical guidance. The fixed plate 21 of the leveling adjustment device 2 can be securely mounted onto the guide rods 531 using a fixing member. As the motor 51 rotates the threaded rod, the lifting platform 532 moves vertically, allowing the leveling adjustment device 2 to adjust its position relative to the calibration jig 4 within the open area 31a.

Referring to FIG. 10, a horizontal calibration method S1 using the horizontal calibration device 3 is provided. The method comprises the following steps. In step S11, each depth gauge 43 of the calibration jig 4 is reset to zero. In step S12, as shown in FIGS. 6A and 6B, the object to be calibrated (e.g., the leveling adjustment device 2) is mounted and fixed onto the supporting structure 53. Specifically, the fixed plate 21 of the leveling adjustment device 2 is fixed onto the guide rods 531 of the supporting structure 53.

In step S13, as illustrated in FIGS. 7A and 7B, the motor 51 is actuated to drive the supporting structure 53 upward via the transmission mechanism 52, until the top surface of the object (e.g., the load-bearing plate 22) comes into contact with one or more extension rods 42 of the calibration jig 4. If the load-bearing plate 22 is tilted or not level, it may not simultaneously contact all the extension rods 42. Even if the load-bearing plate 22 simultaneously contacts all of the extension rods 42, the readings of the respective depth gauges 43 may still vary. To correct this, step S14 involves adjusting the screw rods 231 of the height adjustment mechanisms 23. By rotating one or more of screw rods 231, the vertical position of the load-bearing plate 22 relative to the fixed plate 21 is modified. As the screw rods 231 rotate, the horizontal position of the load-bearing plate 22 changes, which in turn affects the displacement of the extension rods 42, leading to changes in the readings of the depth gauges 43. Therefore, by adjusting the screw rods 231 until the readings of all depth gauges 43 are consistent, it can be confirmed that the load-bearing plate 22 has reached the desired level.

In one embodiment, the bottom surface of the shaft portion 422 of the extension rod 42 is designed with an arcuate or tapered shape. When the load-bearing plate 22 is lifted and its top surface comes into contact with the bottom surface of the shaft portion 422, this design promotes uniform contact pressure, thereby enhancing calibration accuracy.

After completing step S14, proceed to step S15, in which the screw rod 231 is secured using the clamping mechanism 24 to prevent loosening and ensure the stability of the adjustment. Specifically, as illustrated in FIG. 5, once the load-bearing plate 22 has been leveled, the fastening member 242 is engaged with the slot 241 of the load-bearing plate 22. Tightening the fastening member 242 reduces the width of the slot 241, causing deformation in the region surrounding the screw hole 22a and generating a clamping force that securely fixes the screw rod 231 in place.

As described in the foregoing embodiments, the horizontal calibration device and the horizontal calibration method provided by the present invention primarily achieve precise horizontal calibration of an object to be calibrated by means of the calibration jig and the lifting device. Specifically, the platform frame and the lifting device enable precise alignment between the calibration jig and the object to be calibrated, thereby ensuring measurement accuracy. In addition, the lifting device raises or lowers the object to be calibrated, with the depth gauge readings changing accordingly. These readings are then used to adjust the distance between the load-bearing plate and the fixed plate, allowing the load-bearing plate to reach the desired horizontal position. Overall, the present invention provides accurate measurement and stable adjustment, making it suitable for horizontal calibration of various workpieces or products.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A calibration jig, adapted to be mounted on a horizontal calibration device, wherein the calibration jig comprises:
a reference platform having a plurality of through holes extending through a top surface thereof;
a plurality of extension rods, wherein the number of the extension rods corresponds to the number of the through holes, and each extension rod is movably inserted through a corresponding through hole and extends beyond a bottom surface of the reference platform; and
a plurality of depth gauges, each having a probe that is in contact with a top end of a corresponding extension rod, wherein the number and positions of the depth gauges correspond to those of the through holes.

2. The calibration jig according to claim 1, wherein each extension rod comprises a head portion and a shaft portion connected to the head portion, wherein the head portion has a cross-sectional area larger than an opening of the corresponding through hole and is located on the top surface of the reference platform, and the shaft portion is inserted through the through hole.

3. The calibration jig according to claim 2, wherein a bottom surface of the shaft portion is arcuate or tapered.

4. The calibration jig according to claim 1, wherein a plurality of recessed structures are formed on a side surface of the reference platform and are respectively aligned with a plurality of height adjustment mechanisms of an object to be calibrated, so as to expose the height adjustment mechanisms when the calibration jig is mounted on the horizontal calibration device.

5. A horizontal calibration device, comprising:
a platform frame having an open area;
the calibration jig according to claim 1, disposed on a top of the platform frame, wherein the extension rods extend into the open area; and
a lifting device disposed below the platform frame, wherein the lifting device comprises a motor, a transmission mechanism, and a supporting structure, wherein the supporting structure is configured to restrict the position of an object to be calibrated and the transmission mechanism is connected to the supporting structure, and wherein the motor drives the supporting structure to move vertically within the open area via the transmission mechanism.

6. The horizontal calibration device according to claim 5, wherein a mounting portion is provided on a top portion of the platform frame and is configured to secure the calibration jig such that the reference platform remains horizontal.

7. A method of using the horizontal calibration device according to claim 5 for horizontal calibration, wherein the method comprising the steps of:
resetting each depth gauge of the calibration jig to zero;
fixing an object to be calibrated to the supporting structure;
actuating the motor to drive the supporting structure upward via the transmission mechanism until a top surface of the object contacts one or more of the extension rods of the calibration jig; and
adjusting the level of the object until the readings of all the depth gauges become consistent.

8. The method according to claim 7, wherein when the calibration jig is mounted on the platform frame, a plurality of recessed structures on a side surface of the reference platform expose a plurality of height adjustment mechanisms of the object to be calibrated, and the method further comprises a step of adjusting the level of the object using the height adjustment mechanisms exposed by the recessed structures.

9. The method according to claim 7, wherein the object to be calibrated comprises:
a fixed plate;
a load-bearing plate disposed on one side of the fixed plate; and
a plurality of height adjustment mechanisms, wherein each of the height adjustment mechanisms is installed between the fixed plate and the load-bearing plate and comprises:
a screw rod, one end of which is threaded into a screw hole of the load-bearing plate, and the other end of which extends toward the fixed plate and has an arcuate surface;
a gasket disposed between the screw rod and the fixed plate, wherein a surface of the gasket facing the screw rod is in surface contact with the arcuate surface; and
a fixing member passing through the screw rod and the gasket and being fixed to the fixed plate; and
wherein the method further comprises rotating one or more of the screw rods to adjust the level of the load-bearing plate until the readings of all the depth gauges become consistent.

10. The method according to claim 9, wherein the object to be calibrated further comprises a clamping mechanism including:
a slot extending through a side surface of the load-bearing plate and communicating with the screw hole; and
a fastening member being inserted into the slot from the side surface or another side surface of the load-bearing plate; and
the method further comprises tightening the fastening member into the load-bearing plate, thereby reducing the width of the slot and deforming a portion of the load-bearing plate around the screw hole to clamp the screw rod.
